(19) United States
(12) Patent Application Publication
(10) Pub. No.: US 2005/0133089 A1
(43) Pub. Date: Jun. 23, 2005

(54) Evaporative gas control valve structure

(75) Inventors: Tetsuya Takahashi, Sashima-gun (JP); Hiroshi Shimamura, Sashima-gun (JP)

Correspondence Address: OLIFF & BERRIDGE, PLC, P.O. BOX 19928, ALEXANDRIA, VA, 22320, US

(73) Assignee: KYOSAN DENKI CO., LTD., Sashima-gun (JP)

(21) Appl. No.: 11/005,043

(22) Filed: Dec. 7, 2004

(30) Foreign Application Priority Data
Dec. 18, 2003 (JP) 2003-420462

(51) Int. Cl. F16K 24/04

(52) U.S. Cl. 137/202

(57) ABSTRACT

An evaporative gas control valve structure includes a casing which is attachable to a fuel tank. A float is disposed in a space formed in the casing, and is movable upward and downward in the space formed in the casing. A valve element is provided on an upper portion of the float. A ventilation passage is provided on a downstream side of the valve element. In addition, a ventilation hole is formed below the casing, and allows communication between the space in the casing and an inside of the fuel tank, and introduces fuel in the fuel tank into the space. A tortuous passage which suppresses a flow of the fuel is provided between the float and the ventilation hole.

### BACKGROUND OF THE INVENTION

The disclosure of Japanese Patent Application No. 2003-420462 filed on Dec. 18, 2003 including the specification, drawings and abstract, is incorporated herein by reference in its entirety.

1. Field of Invention

The invention relates to an evaporative gas control valve structure which is provided in a ventilation passage which allows communication between a fuel tank and a canister.

2. Description of Related Art

A fuel tank for storing fuel to be supplied to a combustion chamber of an engine is provided in an automobile, for example. A ventilation system is provided in the fuel tank such that an amount of air which corresponds to an increase/decrease in an amount of the fuel in the tank can flow in/out through the ventilation system. The ventilation system allows communication between the inside of the fuel tank and a canister. When the fuel tank is supplied with an excessive amount of fuel, part of the fuel is spilled, and the spilled fuel flows toward the canister. As a result, the canister becomes wet and unusable. Accordingly, a fill-up control valve is provided in an upper portion of the fuel tank, and when the fuel tank is filled up, the fill-up control valve blocks the ventilation system such that the air and the fuel do not flow toward the canister.

Also, two or more fuel leak prevention valves may be attached to the fuel tank. The fuel leak prevention valves are provided in addition to the aforementioned fill-up control valve, and are usually opened to the atmosphere so as to adjust a change in the pressure in the fuel tank. For example, when a vehicle is tilted, when the vehicle is suddenly stopped, when the vehicle suddenly takes off, or when the vehicle is overturned, the fuel leak prevention valves are closed. Further, an in-tank type fuel pump unit is attached to the fuel tank through a flange.

FIG. 8 shows a fuel tank provided with a fill-up control valve and the like. The fuel to be supplied to the engine is stored in the fuel tank 1. A fill-up control valve A is provided in an upper portion of the fuel tank 1. The fill-up control valve A is connected to a canister 4 through a ventilation passage 5. A fuel supply pipe 3 which is closed by a filler cap 2 is attached to the fuel tank 1. Fuel is supplied to the fuel tank 1 through the fuel supply pipe 3 when necessary.

A fuel pump unit 6 and the fill-up control valve A are provided at a center portion of the fuel tank 1. Further, fuel leak prevention valves B and C having the same function are provided at right and left portions.

FIG. 9 shows an example of the aforementioned fill-up control valve A. The fill-up control valve A includes a casing 10 which is inserted in the fuel tank 1; a float 11 which is provided in the casing 10; a spring 12 which applies an upward force to the float 11; a valve element 13 provided in an upper portion of the float 11; a ventilation passage 5 having one end connected to a portion on a downstream side of the valve element 13, and having another end connected to the aforementioned canister 4, and the like.

The casing 10 is a hollow cylindrical container having an upper opening at an upper end thereof and a lower opening at a lower end thereof. A float chamber 17 is formed inside the casing 10. Plural ventilation holes 18a are formed in a side wall of the casing 10. A valve seat 15 is formed in an upper portion thereof. Further, plural perpendicular ribs 16 are radially formed on an inner surface of the casing at equal intervals. The float 11 is guided by the ribs 16 to move upward and downward. A bottom portion plate 19 having ventilation holes 18 is attached to a bottom portion of the casing 10. A flange 14 is formed in an outer periphery in a side portion of the casing 10. The casing 10 is attached to the fuel tank 1 through the flange 14.

The fill-up control valve A has the structure described above. When fuel is supplied to the fuel tank 1 through the fuel supply pipe 3, the liquid surface of the fuel in the fuel tank 1 rises. When the liquid surface reaches the bottom portion plate 19, the fuel enters the casing 10 through the ventilation holes 18 in the bottom portion plate 19 and the ventilation holes 18a of the side wall of the casing 10, and pushes the float 11 upward. Then, when the liquid surface of the fuel in the float chamber 17 reaches a predetermined position, the valve element 13 provided in the upper surface of the float 11 contacts the valve seat 15. When the valve element 13 contacts the valve seat 15, the ventilation passage 5 is closed. Therefore, when fuel is supplied thereafter, the pressure in the fuel tank 1 is increased, and then the fuel supply is stopped. The liquid surface of the fuel at this time is regarded as a fill-up liquid surface position H.

FIG. 10 shows an example of the aforementioned fuel leak prevention valves B and C. Each of the fuel leak prevention valves B and C has the following characteristics. Each of the fuel leak prevention valves B and C is provided at a position higher than the position of the fill-up control valve A. A passage 20 connects a portion on a downstream side of the valve element 13 with the ventilation passage 5 as shown in FIG. 10. Also, the valve element 13 of each of the fuel leak prevention valves B and C has the shape as shown in FIG. 10. Other portions of the structure thereof are substantially the same as those of the fill-up control valve A in FIG. 9. Therefore, the portions which are the same as those in FIG. 9 are denoted by the same reference numerals, and description thereof will be omitted.

Since the fuel leak prevention valves B and C are provided at the position higher than the position of the fill-up control valve A, the fuel leak prevention valves B and C are not closed when fuel is supplied. That is, the fuel leak prevention valves B and C are usually opened. Each of the fuel leak prevention valves B and C is provided through the flange 14 on an upper surface at a portion where an enclosed space is formed when the fuel tank 1 is tilted. The passage 20 allows communication between the portion and the canister 4, and thus a change in the pressure is reduced. With this arrangement, the fuel leak prevention valve B or C may sink in the fuel depending on the direction in which the fuel tank 1 is tilted. In this case, in the fuel leak prevention valve B or C, the float 11 is moved upward, and the valve element 13 contacts the valve seat 15 so as to close the passage 20. Therefore, the fuel does not flow out of the fuel tank 1 and to the canister 4.

As described above, each of the fill-up control valve A, and the fuel leak prevention valves B and C has the ventilation holes 18a in the side wall of the casing 10 and the ventilation holes 18 in the bottom portion plate 19. When the liquid surface of the fuel rises, for example, when fuel is supplied, the fuel is introduced to the float chamber 17 in the casing 10 through the ventilation holes 18a and the ventilation holes 18. Thus, the float 11 is moved upward, and the valve element 13 contacts the valve seat 15 so as to close the valve, whereby the outflow of the fuel to the ventilation passage 5 is suppressed.

However, when the fuel in the fuel tank is oscillated, for example, when fuel is supplied, or the vehicle is turned, the liquid surface of the fuel is rapidly oscillated. Therefore, the moving fuel at this time rapidly flows into the float chamber 17 through the ventilation holes 18a and the ventilation holes 18. As a result, the fuel may flow to the ventilation passage 5 (or 20) before the float 11 is moved upward and the valve is closed, and the fuel may directly flow out to the canister.

### SUMMARY OF THE INVENTION

It is a first object of the invention to provide an evaporative gas control valve structure which suppresses the direct outflow of fuel to a canister even when a liquid surface of fuel is rapidly oscillated.

In order to achieve the first object, according to a first aspect of the invention, an evaporative gas control valve structure includes a casing which is attached to a fuel tank; a float which is provided in a space formed in the casing; a ventilation hole which is formed below the casing, and which allows communication between the space and an inside of the fuel tank, and introduces fuel in the fuel tank to the space; and a member which suppresses a flow of the fuel, and which is provided between the float and the ventilation hole.

With this configuration, when the fuel in the fuel tank is oscillated, for example, when fuel is supplied, or a vehicle is turned, even if the liquid surface of the fuel is rapidly oscillated and the moving fuel tries to rapidly enter the float chamber through the ventilation hole formed below the casing, the member provided between the float and the ventilation hole suppresses the rapid flow of the fuel before the fuel enters the float chamber. Accordingly, the valve is efficiently closed by the float. Thus, it is possible to reduce the outflow of the fuel to the canister.

In the first aspect of the invention, a member that contacts a lower end of the float may be provided in the casing, and plural ventilation holes may be formed in the member at a portion thereof that contacts the lower end of the float. With this configuration, even if the fuel enters the float chamber at normal times or when the liquid surface of the fuel is rapidly oscillated, since part of the fuel enters the plural ventilation holes and thus pushes the float upward, the valve is closed by the float earlier, and the outflow of the fuel to the canister is further reduced.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a cross sectional view showing an evaporative gas control valve structure according to a first embodiment of the invention;

FIG. 2 is a cross sectional view showing an evaporative gas control valve structure according to a second embodiment of the invention;

FIG. 3 is a cross sectional view showing an evaporative gas control valve structure according to a third embodiment of the invention;

FIG. 4 is a cross sectional view showing an evaporative gas control valve structure according to a fourth embodiment of the invention;

FIG. 5 is a cross sectional view of FIG. 4 taken along line V-V;

FIG. 6 is a cross sectional view showing an evaporative gas control valve structure according to a fifth embodiment of the invention;

FIG. 7 is a cross sectional view showing an evaporative gas control valve structure and a fuel pump unit that are integrated with each other;

FIG. 8 is a schematic diagram showing a fill-up control valve, fuel leak prevention valves, and a fuel pump unit that are attached to a fuel tank;

FIG. 9 is a cross sectional view showing a conventional fill-up control valve; and

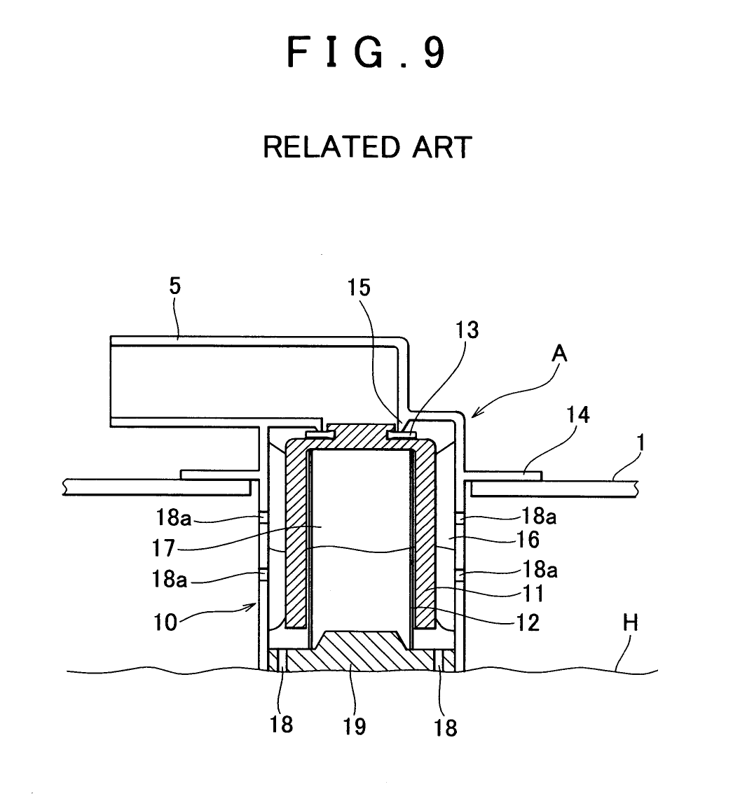

FIG. 10 is a cross sectional view showing a conventional fuel leak prevention valve.

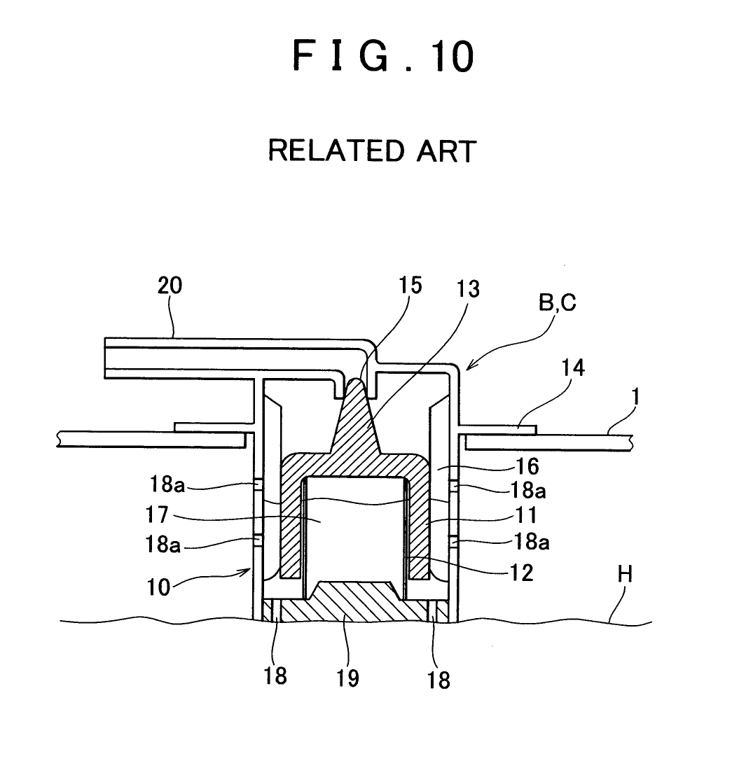

### DETAILED DESCRIPTION OF PREFERRED EMBODIMENTS

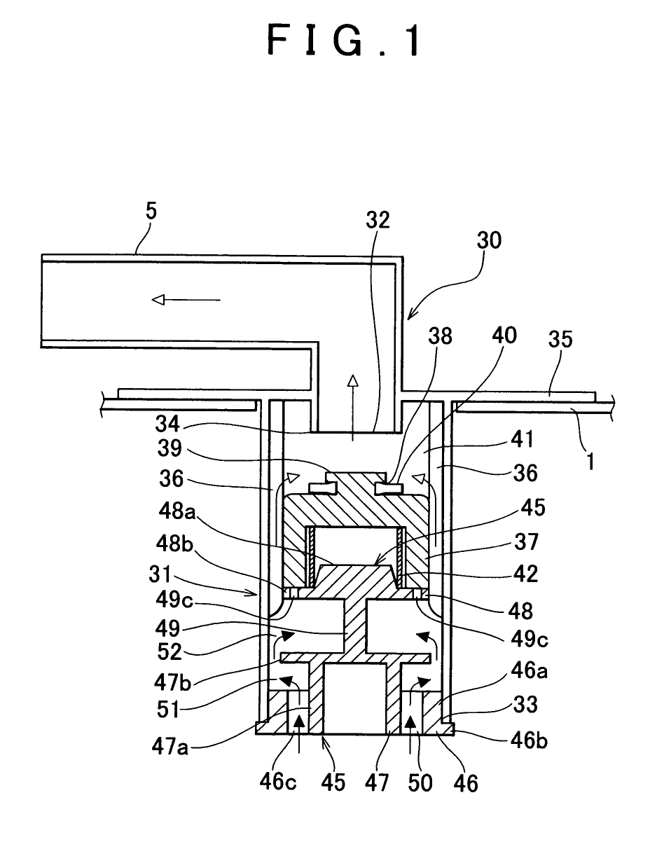

FIG. 1 is a cross sectional view showing an evaporative gas control valve structure. The evaporative gas control valve can be a fill-up control valve or a fuel leak prevention valve. Hereinafter, embodiments in which a fill-up control valve is used will be described.

A fill-up control valve structure 30 according to a first embodiment includes a casing 31, a float 37, a spring 42, and the like. The casing 31 is made of resin. The casing 31 has a hollow cylindrical shape having an upper opening 32 at an upper end thereof and a lower opening 33 at a lower end thereof. The upper opening 32 has a small diameter, and the lower opening 33 has a large diameter. A valve seat 34 is formed on an inner surface of the upper opening 32. A flange 35 used for attaching the fill-up control valve structure 30 to a fuel tank 1 is formed on an outer peripheral surface of the upper opening 32 above the valve seat 34. A ventilation passage 5 is formed integrally with the upper opening 32. Plural perpendicular ribs 36 are provided on an inner surface of the casing 31 at equal intervals in a circumferential direction. Thus, the float 37 is guided by the ribs 36 to move upward and downward.

The float 37 is made of resin. The float 37 has a generally hollow cylindrical shape having a lower opening. A small-diameter protrusion 39 having a columnar shape is formed on an upper surface of the float 37. An annular groove portion 38 is formed on an outer periphery of the small-diameter protrusion 39. An inner peripheral edge of a valve element 40 is fitted into the annular groove portion 38. The valve element 40 is made of rubber and has a ring shape. When the float 37 is moved upward to the uppermost position, an upper surface of the valve element 40 having the ring shape contacts the valve seat 34. As a result, communication between a float chamber 41 formed in the casing 31 and the ventilation passage 5 is interrupted. The valve element 40 having the ring shape is fitted into the annular groove portion 38 such that the valve element 40 is slightly movable in the groove portion 38. Therefore, even if the float 37 is slightly tilted, the communication between the float chamber 41 and the ventilation passage 5 is reliably interrupted.

A spring 42 is provided inside the float 37. The spring 42 is provided between an upper surface of an inner wall of the float 37 and a labyrinth structural body 45 that will be described later. The spring 42 supports upward movement of the float 37. That is, a spring force of the spring 42 does not move the float 37 upward at normal times. However, when fuel enters the float chamber 41, the spring force is added to a buoyant force applied to the float 37 by the fuel so that the float 37 can be moved upward quickly.

The labyrinth structural body 45 is integrally fitted to the lower opening 33 of the casing 31 by welding or other means. The labyrinth structural body 45 includes three members, which are a bottom member 46, an intermediate cylinder member 47, and an upper member 48, which are made of resin. These three members are integrally formed using resin.

The bottom member 46, which is one of the three members, constitutes a bottom plate of the casing 31. The bottom member 46 is a hollow cylindrical member including a hollow cylindrical portion 46a having a small height, and a flange 46b at a lower end thereof. When the labyrinth structural body 45 is inserted from the lower opening 33 of the casing 31, an inner surface of the casing 31 at a lower end contacts an outer periphery of the cylindrical portion 46a. A lowermost end of the casing 31 contacts an upper surface of the flange 46b. Both of the casing 31 and the labyrinth structural body 45 are integrally fixed to each other by welding or other means.

The intermediate cylinder member 47 is provided in a hollow portion of the bottom member 46 so as to be concentric with the bottom member 46. The intermediate cylinder member 47 includes a hollow cylindrical portion 47a having a large height and a horizontally extending portion 47b at an upper portion thereof. A lower end of the hollow cylindrical portion 47a and a lower end of the bottom member 46 are positioned at the same level. An inner surface of the cylindrical portion 46a of the bottom member 46 and an outer surface of the hollow cylindrical portion 47a of the intermediate cylinder member 47 are connected to each other by plural ribs 50 that are provided at equal intervals in a circumferential direction. Plural ventilation holes 46c are formed between the inner surface of the cylindrical portion 46a and the outer surface of the hollow cylindrical portion 47a.

At normal times, the plural ventilation holes 46c allow evaporative fuel gas to be discharged therethrough. For example, when fuel is supplied or a vehicle is tilted, the plural ventilation holes 46c allow the fuel to enter the float chamber 41. For example, when fuel is supplied or the vehicle is tilted, the float 37 is moved upward due to the fuel entering the float chamber 41, and accordingly the valve element 40 provided in the upper portion of the float 37 contacts the valve seat 34, whereby the outflow of the fuel to a canister 4 side is suppressed.

When the hollow cylindrical portion 47a of the intermediate cylinder member 47 is provided inside the cylindrical portion 46a of the bottom member 46, the position of the horizontally extending portion 47b of the intermediate cylinder member 47 is higher than that of the cylindrical portion 46a of the bottom member 46. Thus, a lower chamber 51 is formed between the horizontally extending portion 47b and the cylindrical portion 46a. The ventilation holes 46c are formed on an inner side of the horizontally extending portion 47b in a plan view. The evaporative gas and the fuel entering the lower chamber 51 through the ventilation holes 46c hit a lower surface of the horizontally extending portion 47b. Thus, the evaporative gas and the fuel flow radially outward, and then flow upward.

The upper member 48 is a disk-shaped member which is horizontally provided above the intermediate cylinder member 47. The upper member 48 constitutes a seat member which the float 37 contacts. The upper member 48 includes a thick member 48a at a center thereof, and a thin member 48b at an outer portion thereof. The spring 42 is positioned (i.e., centered) by the thick member 48a at the center, and the spring 42 is provided between an upper surface of the thin member 48b and the upper surface of the inner wall of the float 37.

Plural ventilation holes 49c are formed in the thin member 48b at the outer portion at equal intervals. The lower end of the float 37 contacts the upper surface of the thin member 48b. When the lower end of the float 37 contacts the upper surface of the thin member 48, the plural ventilation holes 49c are closed by the lower end of the float 37. When the fuel flows into an upper chamber 52 that will be described later, the fuel acts on the float 37 through the ventilation holes 49c such that the float 37 is moved upward. Thus, upward movement of the float 37 is supported by the fuel.

The upper member 48 and the horizontally extending portion 47b of the intermediate cylinder member 47 are integrally connected to each other by a bar-shaped support pillar 49 that extends perpendicularly from the center portion of the upper member 48 to the center portion of the horizontally extending portion 47b of the intermediate cylinder member 47. The upper chamber 52 is formed between the upper member 48 and the horizontally extending portion 47b. In this manner, in the labyrinth structural body 45, the lower chamber 51 and the upper chamber 52 are constituted by the three members, which are the bottom member 46, the intermediate cylinder member 47, and the upper member 48. Thus, a tortuous passage (a zigzag passage, or roundabout passage) is formed in the labyrinth structural body 45, as shown by the black arrows. An outlined arrow indicates the flow of the evaporative gas at normal times. The length of the tortuous passage may be set to an appropriate value, by providing an appropriate number of the horizontally extending portions 47b at intervals in a vertical direction between the upper member 48 and a first horizontally extending portion 47b.

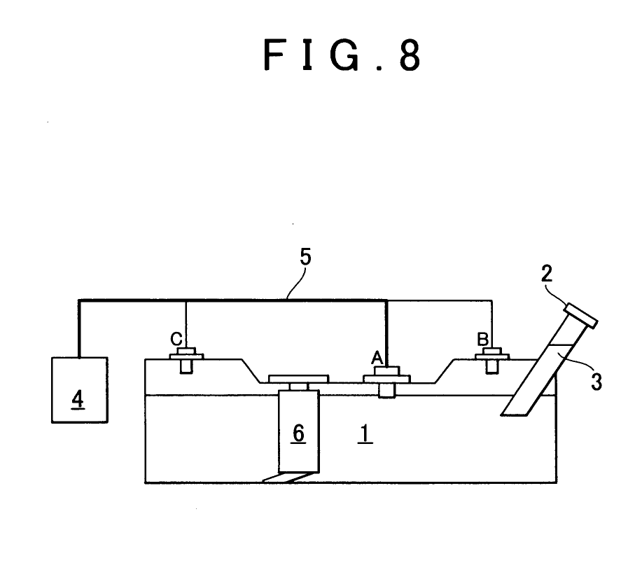

The action of the fill-up control valve structure 30 is as follows. That is, when fuel is supplied through a fuel supply pipe 3 shown in FIG. 8 to the fuel tank 1 to which the fill-up control valve structure 30 is attached, the liquid surface of the fuel in the fuel tank 1 may rapidly oscillate. Also, when the vehicle is suddenly turned, when the vehicle is suddenly stopped, or when the vehicle suddenly takes off, the liquid surface of the fuel in the fuel tank 1 may rapidly oscillate. When the liquid surface of the fuel in the fuel tank 1 is rapidly oscillated, the fuel tries to rapidly enter the float chamber 41 through the ventilation holes 46c of the labyrinth structural body 45 of the fill-up control valve structure 30.

However, since the tortuous passage is formed between the float 37 in the casing 31 and the ventilation holes 46c due to the labyrinth structural body 45 including the three members, which are the bottom member 46, the intermediate cylinder member 47, and the upper member 48, the flow speed of the fuel that enters through the ventilation holes 46c at a high speed is reduced as the fuel passes through the tortuous passage constituted by the lower chamber 51 and the upper chamber 52, as shown by the black arrows. Therefore, the fuel can be prevented from flowing out to the ventilation passage 5 before the ventilation passage 5 is closed by the valve element 40, which is moved by the float 37.

Also, at normal times, at the time of fuel supply, or the like, the evaporative gas containing fuel may enter the float chamber 41 through the ventilation holes 46c, and may try to flow out to the ventilation passage 5. However, since the fuel contained in the evaporative gas is separated from the gas as the evaporative gas passes through the tortuous passage, and the separated fuel flows back through the tortuous passage to the fuel tank 1, it is possible to reduce an adverse effect of the fuel on the canister 4.

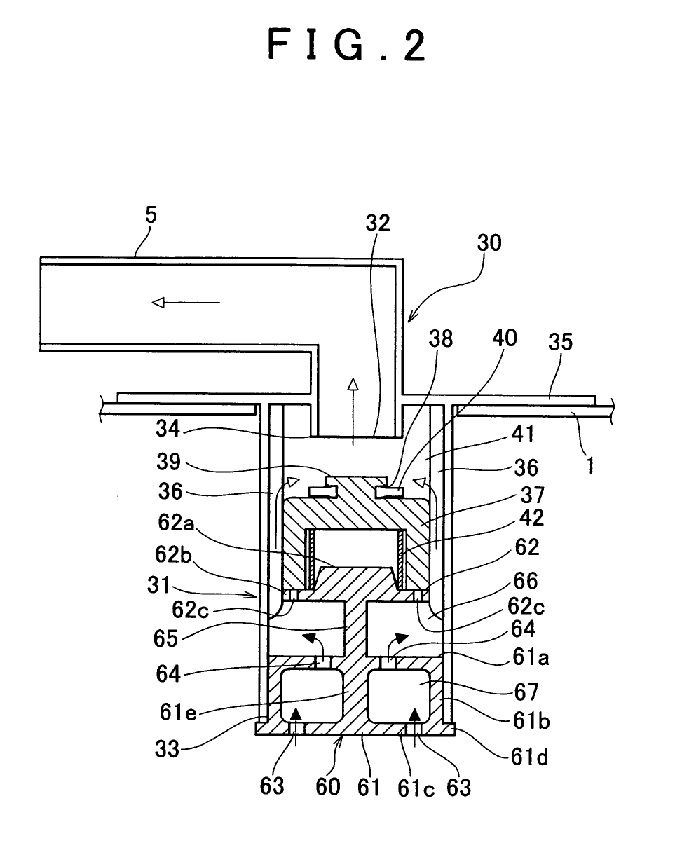

FIG. 2 is a cross sectional view showing an evaporative gas control valve structure according to a second embodiment of the invention. The evaporative gas control valve structure includes a tortuous passage that is different from the tortuous passage according to the first embodiment of the invention. Since the structure according to the second embodiment is the same as the structure according to the first embodiment except for the labyrinth structural body, description of the similar structure will be omitted.

A labyrinth structural body 60 is integrally attached to the lower opening 33 of the casing 31. The labyrinth structural body 60 includes two members, which are a bottom member 61 and an upper member 62, which are made of resin.

The bottom member 61, which is one of the two members, is a hollow member including an upper wall 61a, a side wall 61b, and a bottom wall 61c. In the bottom member 61, there is a space 67 which serves as a passage. A first support pillar 61e for reinforcement extends perpendicularly at the center thereof. A flange 61d is formed in the bottom wall 61c. When the labyrinth structural body 60 is inserted from the lower opening 33 of the casing 31, an inner surface of the casing 31 at a lower end contacts an outer periphery of the side wall 61b, and a lowermost end of the casing 31 contacts an upper surface of the flange 61d. The labyrinth structural body 60 and the casing 31 are integrally fixed to each other.

Further, plural first ventilation holes 63 are formed in the bottom wall 61c at a portion near a radially outer end of the bottom wall 61c. Plural second ventilation holes 64 are formed in the upper wall 61a at a portion near a radially inner end of the upper wall 61a. The tortuous passage is constituted by the first ventilation holes 63, the space 67, and the second ventilation holes 64.

At normal times, the plural first ventilation holes 63 and the plural second ventilation holes 64 allow the evaporative fuel gas to be discharged. At the time of fuel supply or the like, the plural first ventilation holes 63 and the plural second ventilation holes 64 allow the fuel to enter the float chamber 41. At the time of fuel supply or the like, the float 37 is moved upward due to the fuel entering the float chamber 41, and the valve element 40 provided in the upper portion of the float 37 contacts the valve seat 34, whereby the outflow of the fuel to the canister 4 side is suppressed.

The upper member 62 is a disk-shaped member which is horizontally provided above the bottom member 61. The upper member 62 constitutes a seat member which the float 37 contacts when it moves downward. The upper member 62 includes a thick member 62a at a center thereof, and a thin member 62b at an outer portion thereof. The spring 42 is positioned (centered) by the thick member 62a at the center, and the spring 42 is provided between an upper surface of the thin member 62b and the upper surface of the inner wall of the float 37.

Plural ventilation holes 62c are formed at equal intervals in the thin member 62b at a radially outer portion. The lower end of the float 37 contacts the upper surface of the thin member 62b. When the lower end of the float 37 contacts the thin member 62b, the ventilation holes 62c are closed by the lower end of the float 37. When the fuel flows into an upper chamber 66 that will be described later, the fuel acts on the float 37 through the ventilation holes 62c such that the float 37 is moved upward. Thus, upward movement of the float 37 is supported by the fuel.

Further, the upper member 62 and the bottom member 61 are integrally connected to each other by a bar-shaped second support pillar 65 that extends perpendicularly from the center portion of the upper member 62 to the center portion of the bottom member 61. The upper chamber 66 is formed between the upper member 62 and the bottom member 61. In this manner, in the labyrinth structural body 60 including the bottom member 61 and the upper member 62, the tortuous passage is constituted by the first ventilation holes 63, the space 67, the second ventilation holes 64, and the upper chamber 66, as shown by black arrows. An outlined arrow indicates the flow of the evaporative gas at normal times.

That is, when the liquid surface of the fuel in the fuel tank 1 is rapidly oscillated, the fuel tries to rapidly enter the float chamber 41 through the first ventilation holes 63 of the labyrinth structural body 60. However, since the tortuous passage is constituted by the space 67, the second ventilation holes 64, and the upper chamber 66 between the float 37 in the casing 31 and the first ventilation holes 63, the flow speed of the fuel that enters through the first ventilation holes 63 at a high speed is reduced while the fuel passes through the tortuous passage, as shown by the black arrows. Therefore, the fuel can be prevented from flowing out to the ventilation passage 5 before the ventilation passage 5 is closed by the valve element 40 moved by the float 37, and at least the possibility of the outflow of the fuel to the ventilation passage 5 can be reduced. The length of the tortuous passage may be set to an appropriate value, by providing the appropriate number of bottom members 61 including the space 67 at intervals in the vertical direction. Therefore, the flow speed of the fuel can be effectively reduced, and the effect of separating the fuel from the evaporative gas, that is, the gas-liquid separation effect can be enhanced.

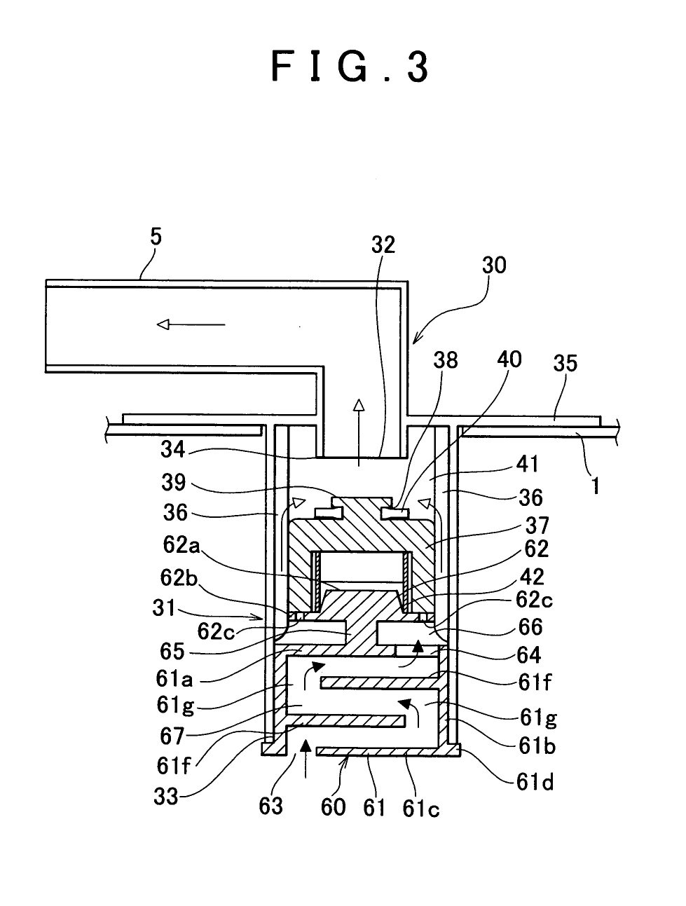

FIG. 3 is a cross sectional view showing an evaporative gas control valve structure according to a third embodiment of the invention. In the evaporative gas control valve according to the third embodiment, the shape of a tortuous passage (zigzag passage) constituted by a bottom member is different from the shape of the tortuous passage according to the first and second embodiments. Therefore, the third embodiment will be described focusing on the portions different from those in the previous embodiments.

The labyrinth structural body 60 is integrally attached to the lower opening 33 of the casing 31 by welding or other means. The labyrinth structural body 60 includes two members, which are the bottom member 61 and the upper member 62, which are made of resin.

The bottom member 61, which is one of the two members, is the hollow member. The bottom member 61 includes the upper wall 61a, the side wall 61b, and the bottom wall 61c. In the bottom member 61, there is the space 67 which serves as the passage. At least one ventilation hole 63 is formed on one side in the bottom wall 61c, and at least one second ventilation hole 64 is formed on the other side (i.e., the side opposite to the first ventilation hole 63) in the upper wall 61a. Further, two horizontal plates 61f, which are an upper horizontal plate 61f and a lower horizontal plate 61f are provided at an upper position and a lower position, respectively inside the bottom member 61. The lower horizontal plate 61f is fixed to an inner surface of the side wall 61b on a left side in FIG. 3. A gap 61g is formed between an end of the lower horizontal plate 61f and the inner surface of the side wall 61b on a right side in FIG. 3. The upper horizontal plate 61f is fixed to the inner surface of the side wall 61b on the right side in FIG. 3. The gap 61g is formed between an end of the upper horizontal plate 61f and the inner surface of the side wall 61b on the left side in FIG. 3. Thus, the tortuous passage is formed in the space 67, as shown by black arrows.

The bottom member 61 of the labyrinth structural body 60 is configured to have the shape described above. Also, the length of the tortuous passage whose direction reverses may be set to an appropriate value by increasing or decreasing the number of the horizontal plates 61f. Therefore, the flow speed of the fuel can be effectively reduced, and the gas-liquid separation effect can be enhanced.

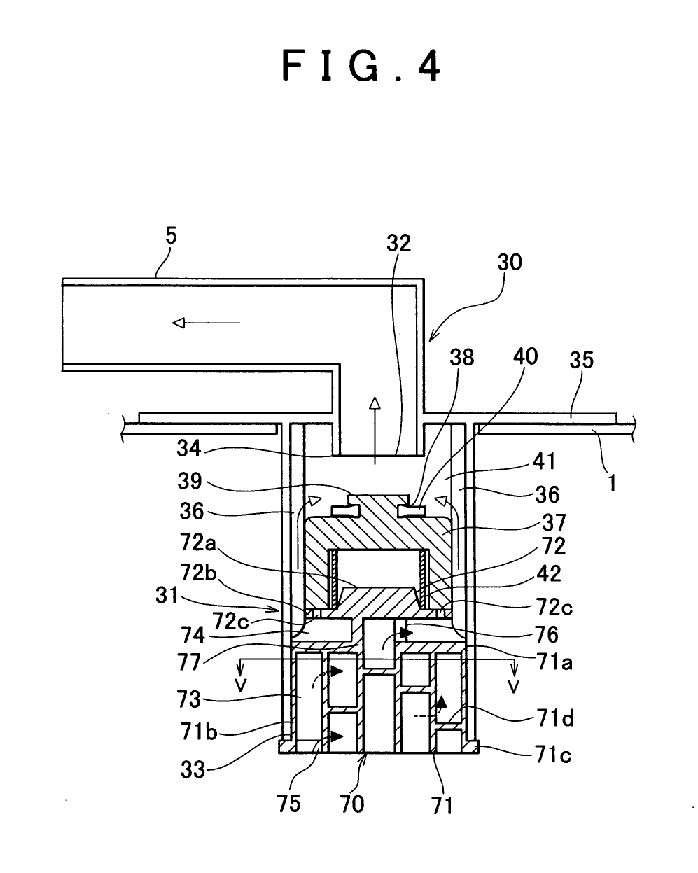

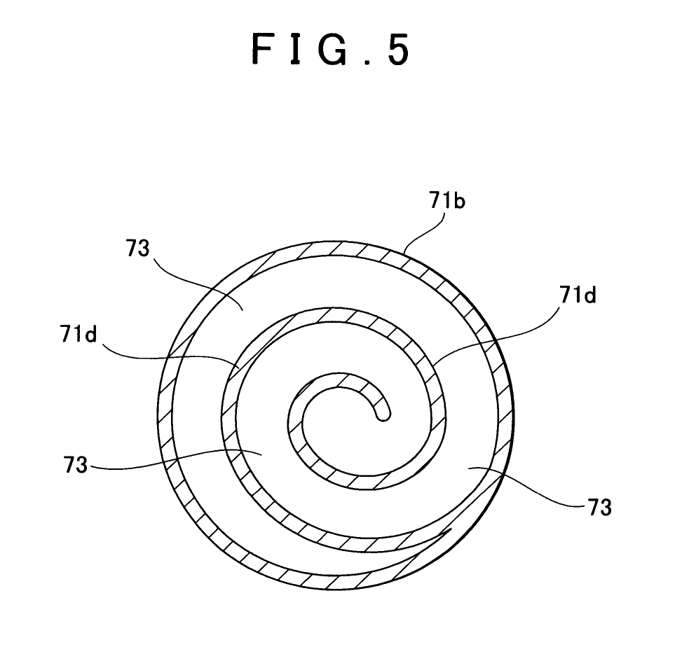

Each of FIG. 4 and FIG. 5 is a cross sectional view showing an evaporative gas control valve structure according to a fourth embodiment of the invention. The evaporative gas control valve structure includes a spiral passage. According to the fourth embodiment, the shape of a bottom member of a labyrinth structural body is different, as compared to the structures according to the first to the third embodiments. Since the structure according to the fourth embodiment is the same as the structure according to the first embodiment in other respects, description of those other respects will be omitted.

A labyrinth structural body 70 is integrally attached to the lower opening 33 of the casing 31 by welding or other means. The labyrinth structural body 70 includes two members, which are a bottom member 71 and an upper member 72, which are made of resin.

The bottom member 71, which is one of the two members, includes an upper wall 71a, a side wall 71b, and a spiral wall 71d. The spiral wall 71d is formed to have a spiral shape in the bottom member 71. A spiral passage 73 is constituted by the spiral wall 71d in the bottom member 71, as shown in FIG. 5. A flange 71c is formed in an outer periphery of the side wall 71b at a lower end. When the labyrinth structural body 70 is inserted from the lower opening 33 of the casing 31, the inner surface of the casing 31 contacts the outer periphery of the side wall 71b, and the lowermost end of the casing 31 contacts an upper surface of the flange 71c. The labyrinth structural body 70 and the casing 31 are integrally fixed to each other by welding or other means.

Further, a first ventilation hole 75 is formed in a bottom portion of the spiral wall 71d. The spiral passage 73 starts at the first ventilation hole 75. Communication is provided between the spiral passage 73 and an upper chamber 74 that will be described later. At normal times, the first ventilation hole 75 allows the evaporative fuel gas to be discharged. At the time of fuel supply or the like, the first ventilation hole 75 allows the fuel to enter the float chamber 41. At the time of fuel supply or the like, the float 37 is moved upward due to the fuel entering the float chamber 41, and the valve element 40 provided in the upper portion of the float 37 contacts the valve seat 34, whereby the outflow of the fuel to the canister 4 side is suppressed.

The upper member 72 is a disk-shaped member which is horizontally provided above the bottom member 71. The upper member 72 constitutes a seat member which the float 37 contacts when it moves downward. The upper member 72 includes a thick member 72a at a center thereof, and a thin member 72b at an outer portion thereof. The spring 42 is positioned (centered) by the thick member 72a at the center, and the spring 42 is provided between an upper surface of the thin member 72b and the upper surface of the inner wall of the float 37.

Plural ventilation holes 72c are formed at equal intervals in the thin member 72b at the outer portion. The lower end of the float 37 contacts the upper surface of the thin member 72b. When the lower end of the float 37 contacts the thin member 72b, the ventilation holes 72c are closed by the lower end of the float 37. When the fuel flows into the upper chamber 74, the fuel acts on the float 37 through the ventilation holes 72c such that the float 37 is moved upward. Thus, upward movement of the float 37 is supported by the fuel.

Further, the upper member 72 and the bottom member 71 are integrally connected to each other by a hollow support pillar 77 that extends perpendicularly from the center portion of the upper member 72 to the center portion of the bottom member 71. A second ventilation hole 76 is provided in the support pillar 77. Communication is provided between the second ventilation hole 76 and the upper chamber 74. Thus, communication is provided between an inside of the fuel tank 1 and the upper chamber 74 through the first ventilation hole 75, the spiral passage 73, and the second ventilation hole 76. In this manner, the labyrinth structural body 70 includes the spiral passage 73, and allows the fuel to enter the upper chamber 74 according to the route shown by black arrows. An outlined arrow indicates the flow of the evaporative gas.

When the liquid surface of the fuel in the fuel tank 1 is rapidly oscillated, the fuel tries to rapidly enter the float chamber 41 through the first ventilation hole 75 of the labyrinth structural body 70. However, since the spiral passage composed of the spiral passage 73 is formed between the float 37 and the first ventilation hole 75, the flow speed of the fuel that enters through the first ventilation hole 75 at a high speed is reduced while the fuel passes through the spiral passage 73 as shown by the black arrows. Therefore, the fuel can be prevented from flowing out to the ventilation passage 5 before the ventilation passage is closed by the valve element 40 moved by the float 37, or at least the possibility of the outflow of the fuel to the ventilation passage 5 can be reduced.

Since the labyrinth structural body 70 is configured to have the shape described above, the spiral passage 73 can be configured to have an appropriate length. Therefore, the flow speed of the fuel can be reduced more effectively, and the gas-liquid separation effect can be further enhanced.

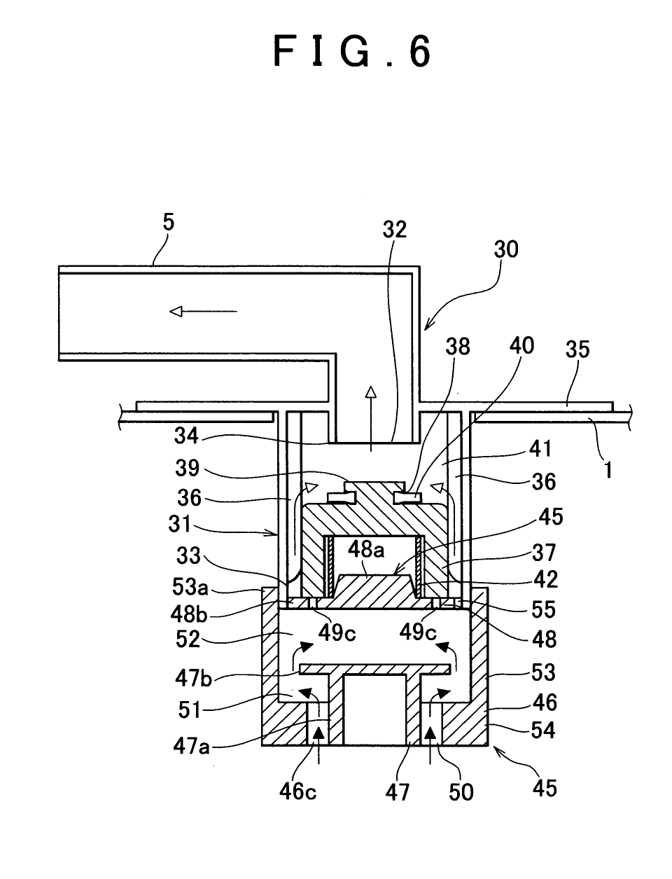

FIG. 6 is a cross sectional view showing an evaporative gas control valve structure according to a fifth embodiment of the invention. A labyrinth structural body of the evaporative gas control valve structure according to the fifth embodiment is basically the same as the labyrinth structural body according to the first embodiment. However, according to the fifth embodiment, the bottom member 46 and the intermediate cylinder member 47 are formed separately from the upper member 48. In the following description of the fifth embodiment, the labyrinth structural body according to the first embodiment is employed. However, the labyrinth structural body according to one of the second to fourth embodiments alternatively may be employed in the fifth embodiment. Components that are the same as those in the first embodiment are denoted by the same reference numerals.

The labyrinth structural body 45 is integrally attached to the lower opening 33 of the casing 31 by welding or other means. The labyrinth structural body 45 includes the three members, which are the bottom member 46, the intermediate cylinder member 47, and the upper member 48 which are made of resin. The bottom member 46 and the intermediate cylinder member 47 are formed separately from the upper member 48.

The bottom member 46, which is one of the three members, is the cylindrical member having an upper opening at an upper end thereof and a lower opening at a lower end thereof. The bottom member 46 includes a hollow cylindrical portion 53 and a bottom plate portion 54 at a lower end thereof. The lower end portion of the casing 31 is inserted into a cylindrical upper end portion 53a of the cylindrical portion 53. Then, the casing 31 and the cylindrical upper end portion 53a of the cylindrical portion 53 are integrally fixed to each other by welding a contact portion therebetween, or by other means.

The intermediate cylinder member 47 is provided in a hollow portion of the bottom member 46 so as to be concentric with the bottom member 46. The intermediate cylinder member 47 includes the hollow cylindrical portion 47a whose height is larger than that of the bottom plate portion 54, and the horizontally extending portion 47b at the upper portion thereof. The lower end of the hollow cylindrical portion 47a and the lower end of the bottom plate portion 54 are positioned at the same level. The inner surface of the bottom plate portion 54 and the outer surface of the hollow cylindrical portion 47a of the intermediate cylinder member 47 are connected to each other by plural ribs 50 that are provided at equal intervals in a circumferential direction. The plural ventilation holes 46c are formed between the inner surface of the bottom plate portion 54 and the outer surface of the hollow cylindrical portion 47a.

When the hollow cylindrical portion 47a of the intermediate cylinder member 47 is provided inside the bottom plate portion 54, the horizontally extending portion 47b occupies a substantially intermediate position in the cylindrical portion 53. Thus, the lower chamber 51 is formed between the horizontally extending portion 47b and the bottom plate portion 54. The ventilation holes 46c are formed on the inner side of the horizontally extending portion 47b in a plan view. The evaporative gas and the fuel entering the lower chamber 51 through the ventilation holes 46c hit the lower surface of the horizontally extending portion 47b. Thus, the evaporative gas and the fuel flow outward, and then flow upward.

The upper member 48 is a disk-shaped member which is horizontally provided in the lower opening 33 of the casing 31, above the intermediate cylinder member 47. The upper member 48 constitutes the seat member which the float 37 contacts when it moves downward. The upper member 48 includes the thick member 48a at the center thereof, and the thin member 48b at the outer portion thereof. The spring 42 is positioned (centered) by the thick member 48a, and the spring 42 is provided between the upper surface of the thin member 48b and the upper surface of the inner wall of the float 37.

The upper member 48 is pressed in the lower opening 33 of the casing 31, as shown in FIG. 6. Then, the upper member 48 is fixed to the lower opening 33 by welding or other means. Plural concave grooves 55 are provided at an outer peripheral end of the thin member 48b. Thus, even when the upper member 48 is attached to the lower end portion of the casing 31, the fuel and the like can flow from a lower side to an upper side.

Further, the plural ventilation holes 49c are formed in the thin member 48b at equal intervals at a position which the float 37 contacts when it moves downward. When the lower end of the float 37 contacts the upper surface of the thin member 48b, the plural ventilation holes 49c are closed by the lower end of the float 37. When the fuel flows into the upper chamber 52 that is formed between the upper member 48 and the horizontally extending portion 47b of the intermediate cylinder member 47, the fuel acts on the float 37 through the ventilation holes 49c such that the float 37 is moved upward. Thus, upward movement of the float 37 is supported by the fuel.

Thus, in the labyrinth structural body 45, the tortuous passage is constituted by the bottom plate portion 54, the intermediate cylinder member 47, and the upper member 48, as shown by black arrows. The labyrinth structural body 45 has the same effect as that of the labyrinth structural body 45 in the first embodiment. An outlined arrow indicates the flow of the evaporative gas. In the fifth embodiment as well, the length of the tortuous passage may be set to an appropriate value by providing the appropriate number of additional horizontally extending portions 47b at intervals in the vertical direction between the upper member 48 and a first horizontally extending portion 47b, through a support pillar (not shown).

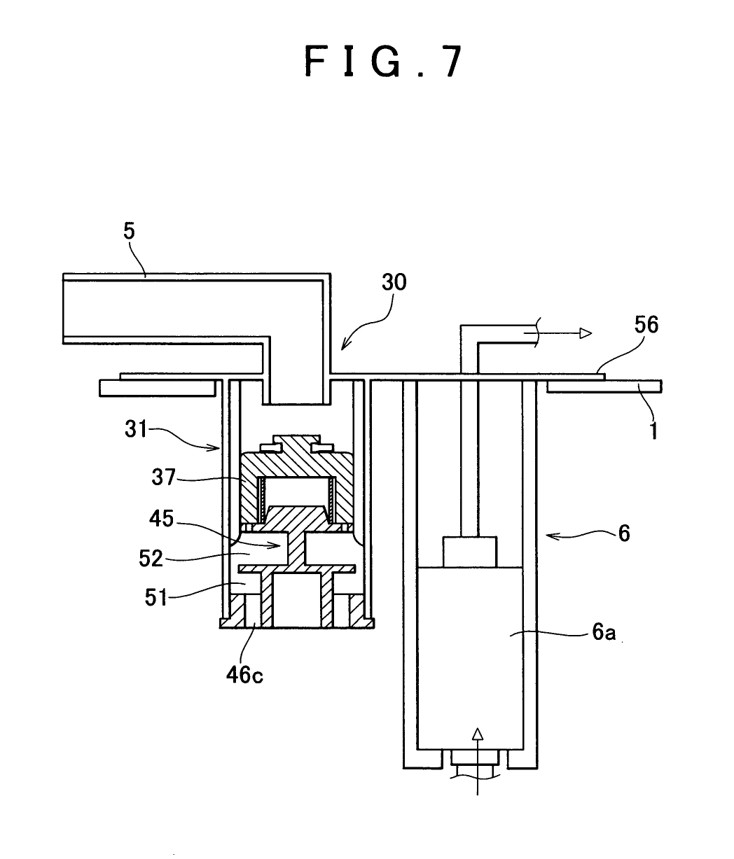

FIG. 7 is a cross sectional view showing an evaporative gas control valve structure according to a sixth embodiment of the invention. In the sixth embodiment, the evaporative gas control valve structure is integrated with a fuel pump unit 6. In the following description of the sixth embodiment, the evaporative gas control valve structure according to the first embodiment is employed. However, the evaporative gas control valve structure according to one of the second to fifth embodiments alternatively may be employed in the sixth embodiment. Components that are the same as those in the first embodiment are denoted by the same reference numerals.

FIG. 7 is a schematic view showing the fill-up control valve structure 30 and the fuel pump unit 6 that are integrated with each other. The fuel pump unit 6 is a known pump which includes a pump main body 6a and a filter and the like (not shown) that are attached to a bottom portion of the pump main body 6a. The fuel pump unit 6 is attached to an upper portion of the fuel tank 1 through a flange 56. The fuel pump unit 6 supplies the fuel in the fuel tank 1 to an engine as shown by an outlined arrow. In FIG. 7, the flange 56 for attaching the fuel pump unit 6 to the upper portion of the fuel tank 1 also is used as a flange for attaching the fill-up control valve structure 30 to the upper portion of the fuel tank 1. Since the fill-up control valve structure 30 is attached to the fuel tank 1 in this manner, it is possible to reduce an area required for attaching the fill-up control valve structure 30 and the fuel pump unit 6 to the fuel tank 1, and to reduce the number of flange components and man hours required for attaching the flange components. Further, since an area through which the fuel (HC) permeates can be reduced accordingly, a fuel permeation amount can be reduced, which contributes to solving an environmental problem.

The invention is not limited to the aforementioned embodiments. Modifications can be appropriately made to the design without departing from the spirit of the invention. For example, in the aforementioned embodiments, the ventilation hole is provided below the casing. However, a second ventilation hole having a small diameter can be provided in a side wall of the casing at an upper side position which moving fuel is unlikely to reach. When the second ventilation hole having the small diameter is provided, the pressure in the fuel tank and the pressure in the float chamber can be made equal quickly. Therefore, the valve element can be moved upward earlier when the fuel tank is filled up.

In the aforementioned embodiments, the passage for suppressing the flow of the fuel is provided between the float and the ventilation hole formed below the casing. Therefore, even if the fuel tries to rapidly enter the float chamber through the ventilation hole, the flow speed of the fuel can be reduced by the tortuous passage, and thus, the valve is reliably closed by the float before the fuel flows out to the ventilation passage. Therefore, thus the adverse effect of the fuel on the canister can be prevented, or at least the possibility of the adverse effect of the fuel on the canister can be reduced. Also, the fuel contained in the evaporative gas can be separated from the gas more reliably while the evaporative gas flows in the tortuous passage. Accordingly, the amount of the fuel flowing out to the canister can be reduced by an amount corresponding to the amount of the fuel separated from the gas, and thus the adverse effect of the fuel on the canister can be prevented, or at least the possibility of the adverse effect of the fuel on the canister can be reduced.

The embodiments of the invention described above include various types of tortuous passages. The invention, however, is not limited to the illustrated embodiments, which are exemplary.

While the invention has been described with reference to exemplary embodiments thereof, it is to be understood that the invention is not limited to the exemplary embodiments and constructions. The invention is intended to cover various modifications and equivalent arrangements. In addition, while the various elements of the exemplary embodiments are shown in various combinations and configurations, which are exemplary, other combinations and configuration, including more, less or only a single element, are also within the spirit and scope of the invention.

1. An evaporative gas control valve comprising:
a casing which is attachable to a fuel tank;
a float disposed in a space formed in the casing, and which is movable upward and downward in the space formed in the casing;
a valve element which is provided on an upper portion of the float;
a ventilation passage which is provided on a downstream side of the valve element;
a ventilation hole which is provided below the casing, and which allows communication between the space in the casing and an inside of the fuel tank, and introduces fuel in the fuel tank into the space; and
suppression means for suppressing a flow of the fuel into the space, the suppression means is disposed between the float and the ventilation hole.

2. The evaporative gas control valve according to claim 1, further comprising:
a seat member which is provided in the casing, and which is contacted by a lower end of the float, wherein plural ventilation holes are formed in the seat member at a portion of the seat member that is contacted by the lower end of the float.

3. The evaporative gas control valve according to claim 2, wherein the suppression means is disposed between the seat member and the ventilation hole, and the suppression means includes at least one wall member extending substantially across a chamber formed between the seat member and the ventilation hole.

4. The evaporative gas control valve according to claim 3, wherein the suppression means includes at least two of the wall members extending substantially across the chamber.

5. The evaporative gas control valve according to claim 1, wherein the evaporative gas control valve is attached to a flange of a fuel pump.

6. The evaporative gas control valve according to claim 1, wherein the suppression means includes a zigzag passage.

7. The evaporative gas control valve according to claim 1, wherein the suppression means includes a spiral passage.

8. The evaporative gas control valve according to claim 1, wherein the suppression means includes a tortuous passage.

9. An evaporative gas control valve comprising:
a casing which is attachable to a fuel tank;
a float disposed in a first space formed in the casing, and which is movable upward and downward in the first space formed in the casing;
a valve element which is provided on an upper portion of the float;
a ventilation passage which is provided on a downstream side of the valve element;
a first member which covers an opening at a lower end of the casing, the first member including a first ventilation hole which allows fuel in the fuel tank to flow into the casing;
a second member which is provided in the casing between the float and the first member such that a second space that is different from the first space is formed between the first member and the second member, the second member including a second ventilation hole; and
a third member which is provided between the first member and the second member, and which interferes with the fuel flowing into the second space through the first ventilation hole.

10. The evaporative gas control valve according to claim 9, wherein the first member, the second member, and the third member are integrally formed.

11. The evaporative gas control valve according to claim 9, wherein the second member is provided so that the float contacts the second member when the float moves downward, and the second ventilation hole of the second member is positioned at a location that is contacted by a lower end of the float.

12. The evaporative gas control valve according to claim 9, wherein a wall of the second member is parallel to a wall of the third member.

13. The evaporative gas control valve according to claim 9, wherein the third member defines an opening that is offset from both the first ventilation hole and the second ventilation hole.

14. An evaporative gas control valve comprising:
a casing which is attachable to a fuel tank;
a float disposed in a first space formed in the casing, and which is movable upward and downward in the first space formed in the casing;
a valve element which is provided on an upper portion of the float;
a ventilation passage which is provided on a downstream side of the valve element;
a first member which covers an opening at a lower end of the casing, the first member including a first hole which allows fuel to flow into the first space in the casing;
a hollow member forming a second space which communicates with the first space formed in the casing through the first hole; and
a second member which is provided in the second space, and which interferes with the fuel flowing into the second space from the fuel tank.

15. The evaporative gas control valve according to claim 14, further comprising:
a third member which closes an opening at a lower end of the hollow member, the third member including a second hole which allows fuel in the fuel tank to flow into the second space formed in the hollow member.

16. The evaporative gas control valve according to claim 15, wherein the second member and the third member are integrally formed, each of which is separated from the casing and the first member.
